SEQUENCE LISTING (6 sequences)

SEQ ID NO: 1 - protein, 12 aa, Artificial sequence
  Derived from peptide library.
SVSVGMKPSPRP

SEQ ID NO: 2 - protein, 9 aa, Artificial sequence
  Derived from peptide library.
CSINWRHHC

SEQ ID NO: 3 - protein, 7 aa, Artificial sequence
  Derived from peptide library.
SINWRHH

SEQ ID NO: 4 - protein, 9 aa, Artificial sequence
  Derived from peptide library.
CHNSHIRWC

SEQ ID NO: 5 - protein, 9 aa, Artificial sequence
  Derived from peptide library.
CTTMHPRLC

SEQ ID NO: 6 - protein, 7 aa, Artificial sequence
  Derived from peptide library.
TTMHPRL

(19) United States
(12) Patent Application Publication
(10) Pub. No.: US 2003/0181376 A1
(43) Pub. Date: Sep. 25, 2003

(54) Control of crop pests & animal parasites through direct neuronal uptake

(76) Inventors: Howard John Atkinson, North Yorkshire (GB); Michael John McPherson, Dewsbury (GB); Michael David Winter, Leeds (GB)

Correspondence Address: SYNGENTA BIOTECHNOLOGY, INC., PATENT DEPARTMENT, 3054 CORNWALLIS ROAD, P.O. BOX 12257, RESEARCH TRIANGLE PARK, NC, 27709-2257, US

(21) Appl. No.: 10/362,768

(22) PCT Filed: Aug. 28, 2001
(86) PCT No.: PCT/EP01/10004

(30) Foreign Application Priority Data
Aug. 30, 2000 (GB) 0021306.6

(51) Int. Cl. A01N 65/00

(52) U.S. Cl. 514/12

(57) ABSTRACT

A method for combating crop pests or animal parasites is provided by contacting them with a peptide which has a molecular weight of 12,000 Dalton or less, which is able to exert its effect after entry into the neurons of the crop pest or in the synaptic cleft and which is able to be taken up through retrograde neuronal transport starting from a sense organ.

### FIELD OF THE INVENTION

This invention relates to effecting control of pests by applying a compound to these pests that has an effect on neuronal transmission processes and that can be taken up through the nerve ending of a sensory neuron. In one embodiment of the invention the pests are crop pests, especially plant parasitic nematodes, arthropods, arachnids, insects, molluscs, and the like, which are able to take up proteins or peptides via their neurones. In another embodiment of the invention the same neuronal uptake is by pests that are parasites of animals or humans especially nematodes, platyhelminths, insects, and the like, which are able to take up proteins or peptides via their neurones. The invention especially relates to transgenic plants which produce proteins or peptides which are able to disturb the neurotransmission in the crop pests, and more in particular which are able to disturb the chemoreception in nematodes. Such disruption arises e.g. when a plant crop pest becomes an endo or ectoparasite of the transgenic plant. For an animal parasite located in the digestive tract of the host it occurs when the host consumes a transgenic plant expressing the protein or peptide or product derived from such a plant. For all parasites of animals and humans it occurs when a medicament is made by extraction of the protein or peptide from a transgenic plant or microbe that expresses the same. Such medicaments can then be used as a food additive, or an anti-parasitic protein or peptide drug presented in any of the ways such compounds are currently used.

### BACKGROUND ART

This invention provides a new basis for control of pests which is defined by the Oxford Concise Dictionary as “troublesome or destructive animals”. In particular the invention is directed to control of those pest animals that damage crops (crop pests) or parasitise humans or animals particularly livestock and companion animals. The majority of the strategies for protecting against crop pest attack or infection deals with the application of pesticides. In most cases the pesticides are organic chemical molecules which have to be applied topically at the place where the pest attacks the organism which needs to be protected. In the case of plants this means spraying the chemical onto the crop, applying during watering of the plants or incorporating it into soil. Since the pesticides which are applied in this way are subject to dispersal due to wind, rain and leakage to soil ground water and degradation by biological processes they often have to be applied at regular intervals. Their single and repeated application constitutes various toxic and environmental threats. The agricultural worker is at risk from chronic or even toxic effects when handling and applying the compounds. Environmental risks occur because of spray drift, dispersal to non-target areas or unwanted toxicity to non-target organisms. The compounds may persist in the soil or gain access to water systems or groundwater. This last subject is covered in detail by Gustafson, D. I., 1993 (Pesticides in drinking water, New York: Van Nostrand Reinhold).

A preferable process would be for plants to make a biopesticide (i.e. a pesticide in planta). To this extent proteinaceous pesticides are advantageous, because they can be expressed in plants through recombinant DNA technology, without needing specific enzymes or substrates and they are expected to be short-lived in the environment and thus much less damaging to it.

However, there are only a few proteinaceous or peptidergic pesticides known. Some of these are toxins, of which the tetanus toxin and the toxins from Bacillus thuringiensis form the most well-known and applied group. A number of cysteine-rich antifungal and anti-microbial peptides have been isolated from plants, particularly from seeds (Garcia-Olmedo, F., Molina, A., Alamillo, J. M., Rodriguez-Palenzuela, P. (1998) Biopolymers 47, 479-491; Broekaert, W. F., Cammue, B. P. A., DeBolle, M. F. C., Thevissen, K., DeSamblanx, G. W., Osborn, R. W. (1997) Critical Reviews in Plant Sciences 16, 297-323). Based on homology these fall into 8 different classes including thionins, lipid transfer proteins and plant defensins. All are compact structures stabilised by disulphide bridges and range in size from 2-9 kDa. They are part of both permanent and inducible pathogen defences.

Examples include: fabatins from broad bean—47 amino acids long, active against bacteria (Zhang, Y. and Lewis, K. (1997) FEMS Microbiology Letters 149, 59-64), small (5 kDa) cysteine-rich antifungal proteins from radish termed defensins (Terras, F. R. G., Eggermont, K., Kovaleva, V., Raikhel, N. V., Osborn, R. W., Kester, A., Rees, S. B., Torrekens, S., Vanleuven, F., Vanderleyden, J., Cammue, B. P. A., Broekaert, W. F. (1995) Plant Cell 7, 573-588), lipid transfer proteins from barley and maize with activity against both bacterial and fungal plant pathogens (Molina, A., Segura, A., Garcia-Olmedo, F. (1993) FEBS Letters 316, 119-122).

The smallest plant-derived antimicrobial peptides isolated to date are from the seeds of Impatiens balsamina (Tailor, R. H., Acland, D. P., Attenborough, S., Cammue, B. P. A., Evans, I. J., Osborn, R. W., Ray, J. A., Rees, S. B., Broekeart, W. F. (1997) Journal of Biological Chemistry 272, 24480-24487). Four closely related peptides each consisting of 20 amino acids are inhibitory to a range of fungi and bacteria. Each contain 2 disulphide bonds and all four are encoded by a single transcript which produces a precursor protein, later processed to release individual peptides.

Anti-microbial peptides from non-plant sources have also been expressed in transgenic plants. Tachyplesin, a 2.3 kDa peptide isolated from horseshoe crab has been expressed in potato resulting in increase resistance to Erwinia soft rot (Allefs, S. J. H. M., DeJong, E. R., Florack, D. E. A., Hoogendoorn, C., Stiekema, W. J. (1996) Molecular Breeding 2, 97-105).

Potato lines expressing magainin II, an antibacterial peptide from Xenopus laevis have been produced (Barrell, P. J., Conner, A. J, Hickford, J .G. H. (1999) MPMI 9th International Conference Proceedings 18.16) and the 38 amino acid lytic peptide cecropin B confers enhanced resistance to bacterial wilt on transgenic tobacco (Jaynes, J. M., Nagpala, P., DeStefano-Beltran, L., Huang, J. H., Kim, J. H., Denny, T. Cetiner, S. (1993) Plant Science 89, 43-53).

Also frequently applied are enzymes like chitinase which are able to break down the chitinous outside of some plant pathogens or pests. In many cases, however, these known proteins are not powerful enough to prevent and/or to stop the pathogen or pest from attacking.

Especially, the proteins or peptides should be active against plant parasitic nematodes that are crop pests. These pests can be subdivided into endoparasites, ectoparasites and ecto-endoparasites of plants. Some are sedentary and others remain mobile as they feed. All use a stylet to pierce plant cell walls and feed by removing plant cell contents before or after plant cell modification. (Symons, P. C. Atkinson, H. J. and Wyss, U. [1994] Annual Review of Phytopathology 32, 235-259). More detail of particular important genera and species, their host ranges and economic importance are defined in standard texts (Luc et al [1990] Plant parasitic nematodes in subtropical and tropical agriculture: Wallingford C.A.B. International; Evans et al [1993] Plant parasitic nematodes in temperate agriculture Wallingford: CAB International). The genera Heterodera and Globodera cyst nematodes are important crop pests. They include H. glycines, (soybean cyst nematode) H. schachtii (beet cyst nematode), H. avenae (cereal cyst nematode) and potato cyst nematodes G. rostochiensis and G. pallida. Root-knot nematodes particularly the genus Meloidogyne, damage a wide range of crops. Examples are species M. javanica, M. hapla, M. arenaria and M. incognita. There are many other economically important nematodes. Both the above groups produce swollen sedentary females as do other economic genera including Rotylenchulus, Nacobbus, and Tylenchulus. Other economic nematodes remain mobile as adult females and many of these cause damage to a wide range of crops. Examples include species of Ditylenchus, Radopholous, Pratylenchus, Helicotylenchus and Hirschmanniella. Others do not always enter plants but feed from them as ectoparasites. Examples include Aphelenchoides, Anguina Criconemoides, Criconema Hemicycliophora, Hemicriconemoides, Paratylenchus and Belonolaimus. Among the ectoparasites the genera Xiphinema, Longidorus, Paralongidorus, Trichodorus and Paratrichodrus have distinctive importance. They cause damage to crops by their feeding but their economic status as crop pests is often due to roles as vectors of NEPO and TOBRA plant viruses.

A wide range of other invertebrates are also crop pests. These include a wide range of insects particularily, Orthoptera, Hemiptera, Diptera, Coleoptera and Lepidoptera and some minor orders such as Thysanoptera and Collembola. A few are also parasites of animals particularly Siphonoptera, Anoplura, and some Diptera. Arachnids are also important pests. In particular this includes mites that are crop pests and ectoparasites of animals and ticks which are ectoparasites of animals. All arthropods often have well defined chemoreceptors and sensing chemicals is important to them in locating food and mates. As with all multicellular invertebrates to which this invention refers, their chemoreceptors have neurones (Wigglesworth V. B. [2000] Insect Physiology 9th ed. London Chapman and Hall.). The wide range of insect and other arthropods that are pests are defined in standard texts (Hill D. S. [1983] Agricultural insect pests of the tropics and their control 2^{nd} ed. Cambridge University Press. Jones, F. G. W. and Jones, M. G. [1984] Pests of Field Crops, 3rd ed. London Edward Arnold. Hill D. S. [1987] Agricultural insect pests of temperate regions and their control Cambridge University Press.). Most molluscs are marine but many gastropod molluscs occur on land and are commonly termed slugs and snails. Many of these are crop pests of considerable economic importance. And they have a well developed sense of chemoreception (Godan, D. [1983] Pest Slugs and Snails, biology and control, 445pp Springer-Verlag, Berlin, South, A. [1992] Terrestrial slugs, biology, ecology and control, 428pp, Chapman and Hall, London). Many oligochaete molluscs such as earthworms are beneficial invertebrates but a few (e.g. enchaetrid worms) browse on roots and can be crop pests. Annelids too have chemoreceptors.

In the case of arthropods particularly insects, some of the commonly applied pesticides are active against both nematodes and insects. Of particular relevance to this invention the oxime carbamate aldicarb is effective at low concentrations against both nematodes and insects and has been used commerically to control both types of crop pest.

Nematodes share a conserved organization including many aspects of their neural system (Ashton, F. T. Li, J. and Schad, G. A. (1999) Veterinary Parasitology 84, 297-316). Details of the life cycle and pathogenicity of these and other parasites are given in standard texts. Examples are: Schmidt, G. M. and Roberts, L. S. (1989) Foundations of Parasitology, Times Mirror/Mosby College Publishing, St Louis, U.S.A. and Urquhart, G. M. et al (1987) Veterinary Parasitology, Longman Scientific and Technical, London, U.K.

The nematode human and animal parasites occur in several groups of nematodes. They include members of the order Ascaridata including Ascaris suum, Ascaris lumbricoides, Ascaridia galli, Anisakis spp, Parascaris equorum, Toxocara canis, T. cati, T. vitulorum and Toxascaris leonina. Another important group are the Trichostrongyles. Examples are Nematodirus battus, Nematodirus spathiger, Nematodirus filicollis, Haemonchus contortus, Trichostrongylus colubriformis, T. tenuis, T. capricola, T. falcatus, T. rugatus, T. axei, Ostertagia ostertagi, O. circumcincta, O. trifurcata, Oesophagostomum radiatum and Cooperia cuticei. Yet another groups is the Strongyloids including Strongyloides stercoralis, S. ransomi and S. papillosus. The Hookworms including Necator americanis, Ancylostoma duodenale, A. ceylanicum, A. braziliense, A. caninum and Bunostomum spp. are also animal parasitic nematodes. Two further groups are members of the Order Trichurata including Trichuris trichuria, T. suis, T. ovis, Capillaria hepatica, C. annulata and C. caudinflata and the Oxyurid nematodes including Heterakis gallinarum, Oxyuris equi, Enterobius vermicularis and E. gregorii.

At present, control of parasitic diseases depends largely on the use of drugs, the control of intermediate hosts and improvements in living conditions, particularly sanitation. Currently used classes of anthelmintics include: (1) Benzimidazoles: They selectively bind β-tubulin and inhibit microtubule production, glucose uptake and enzyme secretion. (2) Levamisole: It is an acetylcholine agonist and inhibitor of fumarate reductase. (3) Piperazine: This is a GABA agonist (4) Macrocyclic lactone: (e.g. Ivermectins & Milbemycins). They facilitate opening of glutamate gated chloride ion channels.

It has been revealed that anti-parasitic protein drugs administered orally as a medicament or expressed in plants used as food for a parasitised animal can provide a treatments against parasites (Atkinson et al. U.S. Pat. No. 5,863,775). In addition certain proteins such as proteinase inhibitors have been shown to be effective against the malaria-causing organism Plasmodium following injection into the blood steam of its host (Rosenthal, P. J. Lee, G. K. Smith, R. E. [1993] Inhibition of a Plasmodium vinckei cysteine proteinase cures murine malaria. Journal of Clinical Investigation 91, 1052-1056.).

Drug treatment is generally expensive, and may need to be repeated frequently whether the aim is prophylaxis or cure. In the third world there are often logistical problems about availability of diagnostic expertise and appropriate medication and with some drugs medical monitoring is necessary. An added difficulty is that there are several examples of drug-resistance. For all the above reasons there is a continual search for new and improved bases for pharmaceutical drugs that provide parasite control.

Thus, there is still need for new pesticides against crop pests and new molecules that are effective against parasites of animals and humans.

### SUMMARY OF THE INVENTION

We now have surprisingly found that exposure of crop pests and parasites such as nematodes to low concentrations of peptides can influence the chemoreception of those crop pests and parasites. Especially useful are peptides that are binding mimetics of certain pesticides (e.g. aldicarb) or anti-parasitic drugs (e.g. levamisole) which disrupt the chemoreception. This is correlated with uptake of molecules of 12 kDa or less by certain neurones associated with chemoreceptors. It provides a novel means of controlling these pests and parasites and a new focus for discovery of new pesticide or anti-parasitic drugs. It reveals a method of uptake that supports identification of new targets for disrupting neuronal function. Anti-parasitic peptides or proteins of suitable size can be delivered by this uptake route. The approach can be used to protect a transgenic plant that expresses such a peptide or protein. The invention can also provide control of animal parasites. A transgenic plant expressing the peptide or protein can be used as a food additive. Alternatively the proteins or peptides can be made in such plants or in microbes and used as medicament or in the other ways in which anti-parasitic drugs are administered.

Also provided are novel peptides which act as binding mimetics of pesticides, particularly binding mimetics of aldicarb and of levamisole. Further part of the invention are vectors expressing said novel peptides and plants transformed with these vectors. Also the use of the peptides for giving resistance to crop pests is part of the invention. Furthermore, the peptides can be used in pharmaceutical compositions or in food or feed for giving parasite control in animals or humans.

### SUMMARY OF THE FIGURES

FIG. 1: The sensory dendrites (D) and cell bodies (CB) of two individual H. glycines (A & B) “filled” with the fluorescent dye FITC. The dye extends down the neuron from the amphids (Am) to the cell body (CB), then via a commissure (CS). The axon enters the nerve ring (NR). In worm B it can be seen that the labelled cell body (CB) and commissure (CS) have a direct connection to the nerve ring. This connection is similar to the ADL neuron in C. elegans. The view is left lateral and the scale bar is 10 μm. A 50 μL aliquot of 5 mg/ml FITC in dimethylformamide was added to 200 μl M9 buffer and nematodes were incubated for 1 to 16 hours in the dark at room temperature. Incubations were carried out in 0.45 μm mini-filter tubes to facilitate stain removal and subsequent washing. Worms were mounted on glass slides and observed under a microscope using epilumination and filters for FITC fluorescence (400×, Leitz DMR B). Images were captured using a CCD camera (Cohu) attached to a PC running Leica QWin image analysis software.

FIG. 2: The infective stage of H. glycines following incubation in bisbenzamide at 1 mg/ml for 16 hours at room temperature in the dark. The chemosensory neural cell bodies (CB) are stained and clearly visible. The stylet (S) is visible due to autofluorescence. Nematodes were viewed described in FIG. 1 except a UV filter was used in place of an FITC filter on the microscope. Scale bar is 10 μm.

FIG. 3: Sensory dendrite (D) in C. elegans filled with FITC/Dextran conjugate of Mᵣ 12 kDa (Sigma). The dye is clearly visible in the dendrite, reflecting transport of the compound from the amphid (Am) to the cell body (CB). The dye is also visible in the lumen (L) of the pharynx due to being swallowed by the nematode. Scale bar is 20 μm. C. elegans was incubated in FITC/Dextrans of various sizes to ascertain the exclusion limits of the sensory neuron. Dextrans were dissolved in PBS at 1 mg/ml and nematodes were incubated in 0.45 μm mini-filter tubes for 16 hours in the dark at room temperature. Nematodes were viewed as described in FIG. 1.

FIG. 4: The response of H. glycines to an attractant disc following incubation in various concentrations of aldicarb (●), constrained (◯) and linear (□) peptide mimetics of aldicarb. Curves were fitted by probit analysis and bars are SEM values.

FIG. 5: Influence of pre-incubation in Levamisole on the ability of infective juveniles H. glycines to aggregate under a disc containing an attractant relative to a control (see example 3 for details). Dotted line (ratio of 1) represents no attraction.

### DETAILED DESCRIPTION OF THE INVENTION

The invention is applicable to all kind of invertebrate animals that are parasites, pathogens or pests and able to take up proteins or peptides via their neurones. These pathogens include, nematodes, cestodes, platyhelminths, arthropods, insects, arachnids, molluscs, annelids and the like.

All plant parasitic nematodes are thought to use chemoreception to locate their hosts and mates and they may be particularly sensitive to disruption at these times and during moving to a feeding site (Perry R. N. [1996] Annual Review of Phytopathology 34, 181-189). Insects too are known to depend on chemoreception in activities such as location of food, feeding and in mate location (Wigglesworth V. B. [2000] Insect Physiology 9th ed. London Chapman and Hall). Chemoreceptors are important to all the groups of invertebrates to which this invention applies. For instance, chemoreception is also an essential feature of animal parasitic nematodes throughout their life cycle. Some have to identify suitable hosts and invade them, and all need to find and maintain themselves at locales within their host. Many undergo complex migrations in the host in order to complete the life cycle. There is a requirement to maintain an optimum position at their locale as parasites. Mature adults use chemoreception to locate one another at mating. Many nematodes also moult in response to chemosensory signals. Influencing chemoreception enables disruption of the life cycle. Therefore some aspects of the current invention have a practical utility for the control of animal parasites.

The compounds according to the invention can be used in many ways after synthesis. As anthelmintics or pesticides they can be administered topically or at the locale of parasites, or pests of plants including the soil and other environments surrounding the plants. They can also be used as pharmaceutical drugs or medicaments topically, by injection or oral administration to animals or humans. They can provide prophylactic or curative treatment for parasites, or crop pests. Alternatively, they can be produced by transgenic organisms to provide a purifiable substance or an extract for use as above. In addition, they can be produced as a biopesticide to protect the transgenic plant in planta from its pathogens, parasites or pests. This can involve constitutive or tissue specific expression of the biopesticide. Expression could also be in response to pathogen, parasite or pest attack and possibly limited to the site of the infection. In a preferred embodiment new pesticides for the control of nematode infection are provided. Plant parasitic nematodes are important plant pests and cause at least $100 billion annually in global crop losses (J. N. Sasser, W. N. Freckman, in: Vistas on Nematology, J. A. Veech, D. W. Dickson, Eds., Soc. Nematol., Hyattsville, Md., 1987, pp. 7-14). The chemical nematicides are the focus of increasing concern over environmental and toxic risk. Consequently, there has been a recent history of progressive withdrawal from use as a result of changes in governmental regulations. It now has been found that peptides can be taken up by the neurones of the nematode. For the nematode Caenorhabditis elegans the functions of the chemoreceptive neurones associated with the anterior sense organs (amphids or sensilla) have been defined by Bargmann and Mori (Bargmann, C. I. and Mori, L., in: C. elegans II, D. L. Riddle, T. Blumenthal, B. J. Meyer, J. R. Priess, Eds., Cold Spring Harbour Press, pp. 717-738, 1997). These neurones have been shown to ‘fill’ with the dye fluorescein iso-thiocyanate (FITC) as do the likely homologous neurones of animal parasitic nematodes (Hedgecock, E. M. et al., Dev. Biol. 11, 158, 1985; Ashton, F. T. et al., Vet. Parasitol. 84, 297, 1999). Now it is established that the chemoreceptory neurones of C. elegans also take up FITC/Dextran conjugates with molecular weights of 4400 Dalton and at least 12000 Dalton. This neuronal uptake is a consequence of neuronal function during chemoreception of molecules in the environment. It follows from these observations and it is further clear from the data presented in the experimental part that the chemoreceptory neurones are also able to take up peptides, proteins and other molecules with a molecular weight of less than 19.5 kD and preferably less than 12 kD.

It will be understood that any peptide or protein which influences the neurones of the crop pest or parasite in such a way that the function is deteriorated will be useful in the invention. Especially useful are peptides which are binding mimetics of antiparasitic drugs (anthelmintics, acaricides, insecticides, etc.) or pesticides (nematicides, insecticides, acaricides, molluscicides, etc.) that interfere with some aspect of neuronal function. In particular this involves neurotransmission facilitated by acetylcholine and in addition mimetics of Levamisole which binds to nicotinic receptors at other sites in nematodes.

In this sense there are four types of target molecules with which the peptides of the invention may interfere. The first series of target molecules are receptor molecules at the sensory sensillae. It is envisaged that blocking or disruption of those target molecules would strongly deteriorate the function of the nematode thereby preventing or hampering its infectiousness.

A second target can be housekeeper functions or other genes essential for the functioning of the chemoreceptive neurones. Examples for specific targets are anterograde or retrograde transport motors. It has been shown in C. elegans that mutants defective in Osm-3 (which is a kinesin-like protein) are nonchemotactic and show defective dauer formation. Also dynein, and its receptor dynactin, are kinesin molecules which would be selectable as targets. The fungicide benomyl is known to interact with kinesin in C. elegans.

A third aim is to target the overall neuronal cell viability. Targets here could be any essential housekeeping compounds. It should be stressed that the best choice would be those housekeeping compounds that would be specific for the crop pest, so as not to interfere with the environment.

A fourth target is neurotransmission. Especially useful are peptides which are able to interfere with the neurotransmission by exerting their effects in the synapse or beyond. In this case GABA-ergic transmission is a target since it has been established that the pesticide piperazine acts as an agonist in GABA-ergic neurones. Ivermectin has effects on glutamate gated chloride channels and on ryanodine receptors. A further, important target are neurones in which the neurotransmission is facilitated by the neurotransmitter acetylcholine (ACh). Interaction with the cholinergic neurotransmission can be pre- and postsynaptic and can be of nicotinic or muscarinic nature.

One embodiment of the invention comprises the peptides SVSVGMKPSPRP (linear peptide) or CSINWRHHC (constrained peptide). It has been found that the peptide SVSVGMKPSPRP is found to be suitable ligand for the alcohol dehydrogenase enzyme from Agrobacterium faecaelis (WO 98/19162). However, this publication does not disclose its effects on crop pests or parasites or its effects on neuronal activity. Another embodiment of the invention comprises a peptide which comprises the amino acid sequence SINWRHH as active site.

Another embodiment of the invention is a peptide which mimics levamisole and which has the amino acid sequence CTTMHPRLC. Database searches do not reveal any peptides that have previously been reported or proteins that contain the peptide sequence TTMHPRL that characterises the binding mimetic of levamisole. Similar peptides have been reported although the relevance of this is not clear at this time. The sequence TIMHPRL occurs in a putative olfactory receptor from Sus scrofa (accession codes AAC26744 and CAB10693) and TTMHPSL occurs in hypothetical protein ZC513.3 of Caenorhabditis elegans (accession codes AAC48265 and T28998). This previous work does not reveal that TTMHPRL is a binding mimetic of levamisole as reported in this invention.

Peptides binding to a known or novel nematode target (protein) can be enriched for by biopanning of a phage peptide library, a process in which peptides are enriched in consecutive rounds of binding to the target, washing of unbound phages and amplification of the bound phage particles, and subsequently cloned, sequenced and validated for binding and functional disruption of the target protein.

Novel potential targets for nematode control can be identified in silico using a comparative genomics approach based on predicted functions and homology to genes from model organisms which are known to be essential for viability of the organism or crucial for important aspects of its pathogenicity (Lavorgna, G., Boncinelli, E., Wagner, A., and Werner, T. (1998) Detection of potential target genes in silico? Trends in Genetics 14(9), 375-376). Such targets can then be validated by functional disruption using RNA interference or by studying knock out mutants of the target gene (WO 00/01846; Bosher, J. M. and Labouesse, M. (2000) RNA interference: genetic wand and genetic watchdog. Nature Cell Biology 2(2), E31-E36; Bird, D. M., Opperman, C. H., Jones, S. J. M., and Baillie, D. L. (1999) The Caenorhabditis elegans genome: A guide in the post genomics age. Annual Review of Phytopathology 37, 247-265).

A further embodiment of the invention provides a plant which has been transformed with a DNA sequence coding for any of the above mentioned peptides. Such a DNA sequence can be obtained by de novo synthesis or by isolating it from a natural source. In order to be expressed properly the DNA sequence must be operably linked to a promoter. The choice of promoter is dependent on the desired site of expression and also on the desired level of expression and the desired way of regulation of the gene under its control. This is all within ordinary skill.

Unless promoter specificity is particularly preferred strong constitutive promoters can be used which function throughout the whole plant, with as little as possible restriction with respect to developmental patterns. One example of a constitutive promoter for high level expression is the CaMV 35S promoter. Other examples of high-level, light-inducible, promoters are, among others, the ribulose biphosphate carboxylase small subunit (rbcSSU) promoter, the chlorophyll a/b binding protein (Cab) promoter, the chimaeric ferrredoxin/RolD promoter (WO 99/31258) and the like.

In combating root-specific pathogens such as nematodes, root-specific promoters are preferable. Examples of such a promoter are: the RolD promoter, RPL16A. Tub-1, ARSK1, PsMTₐ (WO97/20057), and Ataol (Møller, S. G. and McPherson, M. J., 1998, The Plant J., 13, 781-791).

Generally, the DNA construct(s) of choice is/are contained in an expression cassette, which comprises at least a promoter and a transcription terminator. It is well known how such elements should be linked in order to function properly and this can be determined without practising inventive skill. A specific method to increase the level of expression of the small peptides of the invention is to include a multitude of coding sequences for these peptides in one gene construct (so-called polyproteins), wherein after transcription the mRNA or the preprotein is processed in such a way that several repeats of the peptide of the invention are generated.

Transformation of plant species is now routine for an impressive number of plant species, including both the Dicotyledoneae as well as the Monocotyledoneae. In principle any transformation method may be used to introduce chimeric DNA according to the invention into a suitable ancestor cell. Methods may suitably be selected from the calcium/polyethylene glycol method for protoplasts (Krens, F. A. et al., 1982, Nature 296, 72-74; Negrutiu I. et al, June 1987, Plant Mol. Biol. 8, 363-373), electroporation of protoplasts (Shillito R. D. et al., 1985 Bio/Technol. 3, 1099-1102), microinjection into plant material (Crossway A. et al., 1986, Mol. Gen. Genet. 202, 179-185), (DNA or RNA-coated) particle bombardment of various plant material (Klein T. M. et al., 1987, Nature 327, 70), infection with (non-integrative) viruses, in planta Agrobacterium tumefaciens mediated gene transfer by infiltration of adult plants or transformation of mature pollen or microspores (EP 0 301 316) and the like. A preferred method according to the invention comprises Agrobacterium-mediated DNA transfer. Especially preferred is the use of the so-called binary vector technology as disclosed in EP A 120 516 and U.S. Pat. No. 4,940,838).

Tomato transformation is preferably done essentially as described by Van Roekel et al. (Van Roekel, J. S. C., Damn, B., Melchers, L. S., Hoekema, A. (1993). Factors influencing transformation frequency of tomato (Lycopersicon esculentum). Plant Cell Reports, 12, 644-647). Potato transformation is preferably done essentially as described by Hoekema et al. (Hoekema, A., Huisman, M. J., Molendijk, L., van den Elzen, P. J. M., and Cornelissen, B. J. C. (1989). The genetic engineering of two commercial potato cultivars for resistance to potato virus X. Bio/Technology 7, 273-278).

Although considered somewhat more recalcitrant towards genetic transformation, monocotyledonous plants are amenable to transformation and fertile transgenic plants can be regenerated from transformed cells or embryos, or other plant material. Presently, preferred methods for transformation of monocots are microprojectile bombardment of embryos, explants or suspension cells, and direct DNA uptake or (tissue) electroporation (Shimamoto, et al, 1989, Nature 338, 274-276). Transgenic maize plants have been obtained by introducing the Streptomyces hygroscopicus bar-gene, which encodes phosphinothricin acetyltransferase (an enzyme which inactivates the herbicide phosphinothricin), into embryogenic cells of a maize suspension culture by microprojectile bombardment (Gordon-Kamm, 1990, Plant Cell, 2, 603-618). The introduction of genetic material into aleurone protoplasts of other monocot crops such as wheat and barley has been reported (Lee, 1989, Plant Mol. Biol. 13, 21-30). Wheat plants have been regenerated from embryogenic suspension culture by selecting embryogenic callus for the establishment of the embryogenic suspension cultures (Vasil, 1990 Bio/Technol. 8, 429-434). The combination with transformation systems for these crops enables the application of the present invention to monocots.

Monocotyledonous plants, including commercially important crops such as rice, wheat and corn are also amenable to DNA transfer by Agrobacterium strains (vide WO 94/00977; EP 0 159 418 B1; EP 0 856 060; Gould J, Michael D, Hasegawa O, Ulian E C, Peterson G, Smith R H, (1991) Plant. Physiol. 95, 426-434).

### EXAMPLE 1

Uptake of Fluorescent Dyes by the Chemosensory System of Soybean Cyst Nematode

Cysts of soybean cyst nematode (Heterodera glycines) were produced as in previous work (Atkinson et al. 1989, Parasitology 98, 479-487). Cysts of this nematode were isolated from soil that had been used to grow soybean plants by passing the soil through graded sieves. Cysts were partially surface sterilised in malachite green for 30 min and then washed in running water for several hours. Second stage juveniles were obtained by placing the cysts on 35 μm nylon mesh in a dish containing dH₂O and incubated at 26° C. Juveniles were harvested (up to 72 hrs after hatching) and centrifugally washed (at low speed, <300 g, in a microfuge) with dH₂O in a 0.45 μm minicentrifuge filter tube. The nematode suspension was centrifuged down to minimal retentate and then 200 μl of appropriate dye solution was added and worms incubated at room temperature in dark. Adequate staining is achieved in 1-2 hours, although animals can be left overnight without adverse effect on their mobility or viability.

Dye Solutions:

a) 50 μl 5-fluorescein-isothiocyanate isomer I (Sigma Cat. No. F4724) at 20 mg/ml in dimethylformamide was added to 200 μl M9 buffer.

b) 1 mg FITC Isomer I per ml buffered salt solution.

c) Bisbenzamide (Sigma Cat No. B1782): 1 mg/ml in PBS.

Following the period of vital staining, the nematodes were given several centrifugal washes (minimum of 5) with excess of dH₂O in 0.45 μm minicentrifuge filter tube at low speed to reduce dye concentration to a level that did not provide background fluorescence. Solution was made up to approx. 200 μl. Small aliquots of nematode suspension were placed on glass microscope slide, covered with a cover-slip and the edges sealed with acetate paint to reduce evaporation. Worms were relaxed by placing slide on 60° C. hot block for 15-20 seconds. Some observations were made of living animals to ensure the uptake of dye occurred for animals while living.

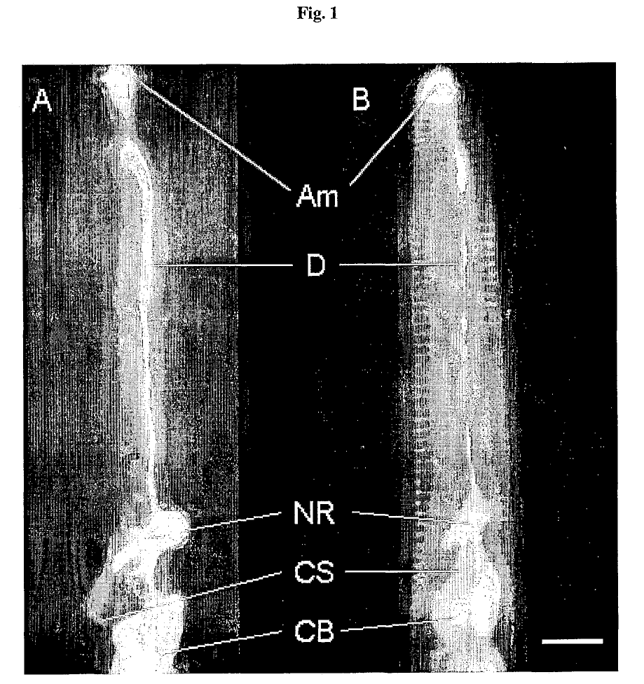

Worms were visualised using a Leica DMR microscope fitted with a black and white camera (Cohu) or colour camera (Kappa). These images were captured using the Leica QWin image analysis equipment and software. FITC uptake was visualised using epifluoresence in the sensory neurosystem from the amphids along the dendrites, to the cell body and past that through a commissure into the nerve ring (FIG. 1).

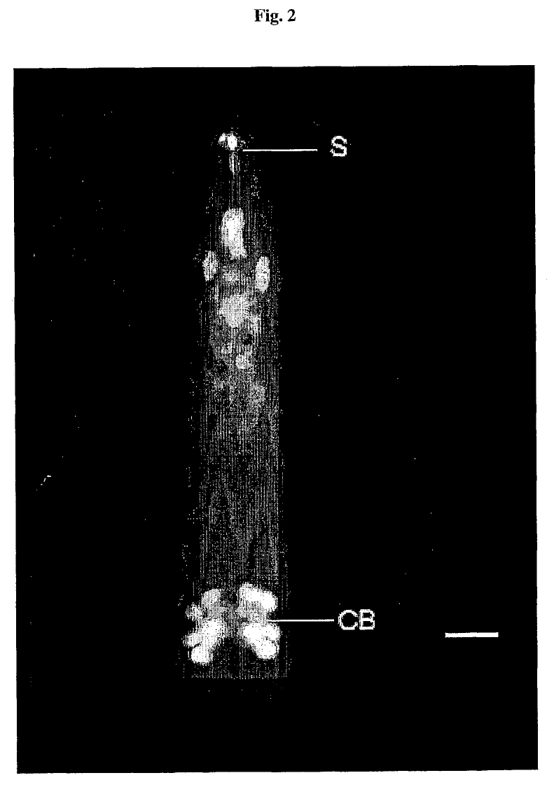

Bisbenzamide fluoresces when it chelates with DNA. After 1-2 hours incubation, the only clearly visible nuclei in plant parasitic nematodes were the nerve cell bodies of certain amphidial neurones. If the worm cuticle is damaged, then every cell nucleus becomes visibly stained. The normally restricted staining occurs because the dye is transported along the sensory dendrites to their nerve cell bodies. It is unlikely that access occurred through the cuticle as other nuclei including those of many neurones were not visualised. The results are consistent with uptake as visualised for FITC. The bisbenzamide does not fluoresce during its passage along the neurone. Fluorescence occurs when it binds to the DNA within the nucleus of the neurone (FIG. 2).

### EXAMPLE 2

Uptake of FITC and Compounds Labelled with FITC by the Chemosensory System of the Free Living Nematode Caenorhabditis elegans.

Nematodes (N2 strain) were maintained as per Brenner (1974 Genetics 77, 71-94). Staining of sensory neurons with FITC was carried out as per Hedgecock et al (1985 Developmental Biology 111, 158-170).

The possibility of a limitation on the size of molecule transported along the neurone was investigated. Three dextrans of varying size (4.4 kDa, 12 kda and 19.5 kDa) that were conjugated to FITC (supplied by Sigma, Cat Nos. FD4, FD10 and FD40 respectively) were used at 5 mg/ml in M9 buffer.

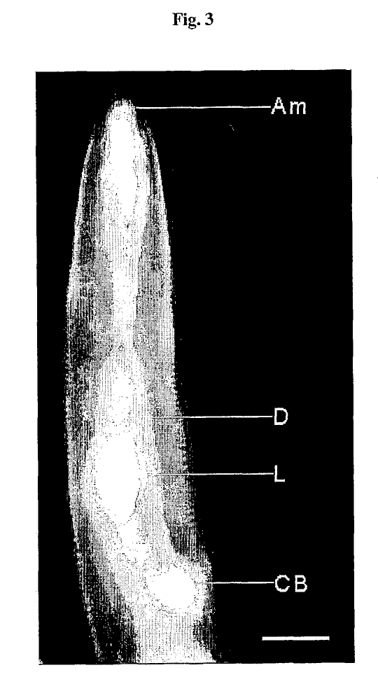

Staining of dendrites and cell bodies was visible in nematodes stained with either 4.4 kDa or 12 kDa FITC-Dextran (FIG. 3). This establishes that certain substances of at least 12 kDa can enter the sensory neurons and are transported along the dendrites to the cell bodies behind the nerve ring.

### EXAMPLE 3

Behavioural Bioassay to Assess Effects of Nematicide and Other Substances on the Ability of Heterodera glycines and Globodera pallida to orientate to host root exudate.

This assay was modified from that used by Grundler et al (Parasitology 103, 149-155; 1991). Soybean plants were grown in pots containing perlite in a tropical glasshouse until the root system was well established. Plants were carefully washed free of the perlite in running water and then several plants were placed in 200 cm3 dH₂O in a conical flask which was covered in foil to keep light off the roots and then incubated in a Sanyo plant growth cabinet (16 hr light 24° C., 8 hr dark 20° C.) for 48hrs. The root exudate was collected and filter sterilised through 0.45 μm syringe filter.

Agarose discs covered in either dH₂O or root exudate were made as follows. Agarose (3 ml, 1.5% solution made in dH₂O) was poured into 6 cm petri dishes and allowed to surface dry. One ml of root exudate or dH₂O was pipetted onto the plates, the surface covered by swirling and then left to completely evaporate. A cork borer was used to cut out 6 mm discs from the plate.

The oxime carbamate nematicide Aldicarb was obtained by putting 1 g Temik (10G, Rhône-Poulenc), in 10 ml chloroform to dissociate the oxime carbamate from its inert carrier. After 1 hour particulate material was removed by centrifugation. 100, 10 or 1 μl aliquots of the chloroform/aldicarb solution were pipetted into 1.5 ml microtubes and left to evaporate in a fume hood. This leaves 1, 0.1 and 0.01 mg aldicarb respectively in each tube. Addition of 1 ml dH₂O to these tubes provides solutions of 5.25 μM, 0.525 μM and 0.0525 μM respectively.

Aliquots of juveniles of H. glycines were incubated for 16 hours in a range of concentrations of aldicarb, or in peptides generated that recognise the same acetylcholinesterase (AChE) target as aldicarb (see example IV). The effect of different concentrations of aldicarb or peptides on chemoreception was measured. Control worms were incubated in either water or PBS for the peptide experiments.

Treated nematode juveniles (approximately 300) in small volumes (typically 20 μl) dH₂O were placed in the centre of 3.5 cm diameter petri dishes containing 1.5 ml 1.5% agarose. After evaporation of the water the worms were left for 1 hour to randomly distribute over the plate. A root exudate and a water agarose test disc were placed onto the plate equally spaced (5 mm) from the centre. The plates were left for 1 hour at room temperature in the dark. The experiments were carried out in replicates of 8-10 per concentration of aldicarb or peptide assayed. Controls in which nematodes were not treated with any chemical or peptide mimetic were also used for each experimental day to obtain a 100% rate of attraction. This allowed measurements of the extent of chemoattraction mediated by a test compound on any day.

The number of worms under each disc was counted using a dissecting microscope. In control experiments typically 2-4 times as many worms were counted under the root exudate disc as were under the water control disc. The numbers of responders minus the number under the control disc was used to calculate a response. With ˜300 animals on the plate the difference was around 40-80. The difference between the numbers under the attractant and the control discs was used to define the maximum response on that day of experiments. Both of the AChE recognising peptides and aldicarb were able to disrupt chemosensory attraction completely at concentrations lower than those which cause paralysis.

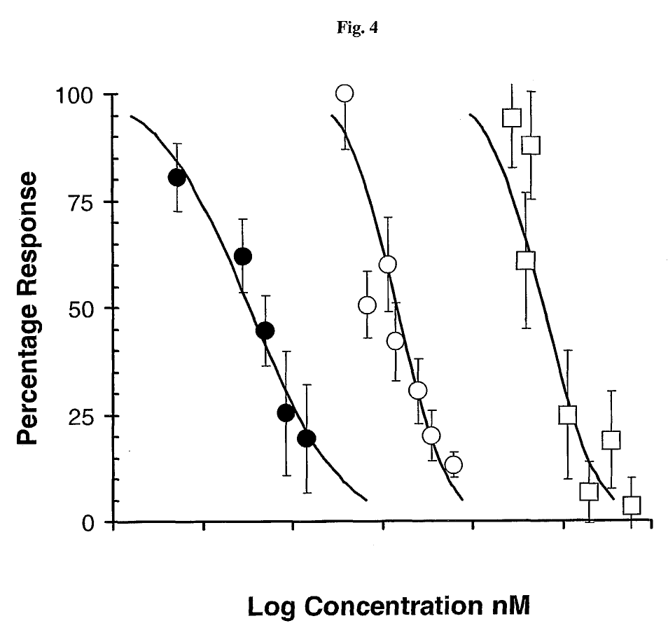

Various concentrations of these compounds were tested with a modified bioassay. The large data set involving means for many replicates at each of several concentrations of test compound is given in FIG. 4. The data sets were analysed using probit analysis within a standard statistical package (SPSS) installed on a personal computer. There was a 50% reduction in attraction of H. glycines to an attractant after incubation for 16 hours in either 1.1±3.06 pM aldicarb, 2.16±6.54 nM constrained 7 mer peptide or 3.68±33.6 μM linear 12 mer peptide. Incubation of H. glycines in the control peptide at 2 μM (10³ more concentrated than that required for 50% disruption with the AChE constrained peptide) resulted in no loss of chemoreception. Even higher concentrations of aldicarb and both AChE binding peptides were needed to inhibit movement than required to disrupt chemoreception.

50 mM CaCl₂ was used as an attractant with the agarose discs. Those assays were carried out at 27° C. This gave similar results to plant root exudate at room temperature with H. glycines. This establishes that the disruption of orientation to more than one attractant can be achieved using these inhibitors. The peptide was also tested against the potato cyst nematode Globodera pallida using the same methods as described for H. glycines. G. pallida was incubated for 16 h in a solution containing the constrained peptide at 1.242×10⁻⁸ M at room temperature. The worms tested using the bioassay described at 20° C. and 50 mM ZnCl₂ as an attractant. The mean value ratio of nematodes under the disc with the attractant rather than without it was 1.64±0.19. In contrast, G. pallida pre-treated with the peptide showed a corresponding ratio of 0.77±0.08. These values are significantly different (P<0.001; t-test). As values>1 indicate a chemoreceptive response, the data establishes a total loss of chemoreception after pre-treatment with this concentration of the peptide. Chemoreceptive function was still inhibited 3 hours after the start of the bioassay. The ratios for untreated and peptide treated G. pallida were significantly different. The means were 1.68±0.24 and 0.78±0.06 respectively and significantly different (P<0.01; t-test). This shows that the effects of the peptide remain after the nematodes have been removed from the treatment for 3 hours.

### EXAMPLE 4

Biopanning of Phage Library to Discover Peptides Which Inhibit Acetylcholinesterase.

A 200 μl suspension of Torpedo acetylcholinesterase (AChE) bound to agarose beads (Sigma, Cat. No. C2511) was used to isolate peptide sequences from 2 phage peptide libraries, one a linear 12 mer and one constrained 7 mer. These libraries are available commercially (New England Biolabs). Phage (approx. 10¹¹ particles) were taken from the library (approx. 10⁹ different sequences) and biopanned against the agarose bound cholinesterase in 1 ml PBS-Tween buffer in microtubes for 1 hour on a rotator. Several centrifugal washes in buffer were used to remove unbound phage. The agarose beads were then incubated in 1 ml 5.25 μM aldicarb for 1 h. This eluted the phage which were specifically bound to the acetylcholinesterase/agarose complex. These eluted phage were amplified overnight in 20 ml host E. coli culture and the phage particles concentrated and titred. The phage selectively eluted and amplified were used for 3-4 further rounds of biopanning, with stepped increases in the concentration of tween-20 to select for increased stringency of binding on each occasion.

After biopanning was completed, amplified phage population was titred on agar plates over a range of dilutions to allow selection of clones. On plates with <200 plaques, clones were selected using sterile wooden picks and each one was transferred into a separate well on a sterile 96 well plate, containing 200 μl E. coli culture per well. The plate was incubated at 37° C. shaking incubator for 4.5 hrs. The plates were then centrifuged in a plate centrifuge at 4° C. to remove cells from the suspension. Supernatant was transferred to a fresh sterile plate, before the addition of glycerol to allow freezing of clones.

The ability of isolated clones to bind AChE was assayed. An enzyme linked immuno-sorbent assay (ELISA) was developed. Torpedo AChE (Sigma Cat. No. C3389) was immobilised onto 96 well plates (Nunclon) at 5 μg/ml in bicarbonate buffer (pH 8.6) overnight at 4° C. Aliquots of the isolated clone supernatant (30 μl added to 70 μl TBS-Tween) were tested in duplicate (2 plates) to screen for binding. The pooled amplified final biopan was used as a positive binding control (2 μl in 98 μl TBS-Tween). The plate was incubated at room temperature for 1 h on a plate shaker, then given 3×5 min washes in TBS-Tween to remove unbound phage. 100 μl of anti-M13 peroxidase conjugated antibody (Pharmacia) was used at a dilution of 1:4000 in TBS-Tween to detect the specifically bound phage. The plate was incubated for a further hour on the shaker at room temperature followed by 3 more 5 min washes in TBS-Tween buffer. The conjugated antibody was detected using 150 μl o-Phenylenediamine dihydrochloride solution (Sigma Cat. No. P9187). Once colour developed, the reaction was stopped by the addition of 30 μl 2M H₂SO₄ to all wells. Plates were read using a BioRad plate reader (Model 3350) with a 492 nm filter. Clones which showed a level of binding more than twice that of a negative control (M13 helper phage with no peptide insert) were amplified. DNA from the clones was precipitated and 500 ng DNA was added to a tube with a specific primer adjacent to the peptide-encoding insert together with dye-terminator chemistry sequencing mix. Linear PCR was carried out and the DNA was extracted using phenol/chloroform. The DNA precipitate was re-suspended in buffer and run on a sequencing gel using an ABI 373A DNA sequencer.

Although the sequence was different for the linear and the constrained peptide library, all clones which bound AChE in a specific library contained the same peptide sequence. These 2 peptides SVSVGMKPSPRP (from the linear library), CSINWRHHC (from the constrained library) and a control constrained peptide (CHNSHIRWC) made of a randomisation of the 7-mer sequence (SINWRHH) were synthesised by a commercial agent.

### EXAMPLE 5

Biopanning of Peptide Mimetic of Levamisole Using Nematode Nicotinic Acetylcholine Receptor (nAChR).

C. elegans (N2 wildtype) were grown on 9 cm agar plates using Nematode Growth Medium and E. coli (OP50). Once well populated, the worms were washed off the agar plate using 2 ml ice-cold MAN buffer (10 mM 3-(N-morphilino)propanesulfonic acid, pH 6.8, 100 mM NaCl, 10 mM NaN₃), collected into 15 ml test tube and left to settle for 5 min. The worm pellet was passaged to a fresh tube of 2 ml ice-cold MAN buffer, left to settle and the process repeated again.

To make a membrane suspension, the worm pellet was sonicated on ice in 5×10 s bursts on full power diluted 1:1 with ice-cold MAN buffer. The homogenate was freeze thawed×5 in liquid N₂. Homogenate was then transferred to a Dounce homogeniser and subjected to 5×30 passes of the homogeniser on ice with 5 min gap between each 30 passes. Volume was made up to 1.5 ml in ice-cold MAN buffer and spun at 33,000 g for 30 min at 4° C. Pellet was resuspended in 1 ml ice-cold MAN buffer, aliquoted into 100 μl samples, snap frozen in liquid N₂ and stored at −80° C. until required.

100 μl aliquot of membrane fraction was diluted in 900 μl TBS with 0.1% Tween 20. 10 μl of original constrained phage library was added to this and incubated on a rotator for 1 hr. To remove unbound phage, the membrane fraction was pelleted by centrifugation at 13,000 g in a microfuge at 4° C. for 5 mins, supernatant removed, then the pellet was resuspended in 1 ml fresh TBS Tween. This was repeated 5 times followed by a final wash in TBS with no Tween.

Phage that specifically bound to nAChR were eluted using Levamisole at 10 mg/ml in TBS. The membrane fraction was pelleted by centrifugation and the supernatant retained and amplified for 4.5 hrs at 37° C. in host E. coli as previously described. This amplified first fraction was titred and the biopan against C. elegans membrane fraction was repeated using fresh extract with phage at an initial input value of 1×10¹¹ pfu.

After 2^{nd} round of biopanning, a 10 minute buffer wash was retained to investigate levels of specific elution by titring both buffer and Levamisole elution.

Buffer 1.6×10⁴ pfu in 10 μl

Levamisole 2.9×10⁵ pfu in 10 μl

The second biopan eluate was re-panned without amplification to overcome possible problems with contamination by wild type M13 from OP50 in the membrane fraction. Wild type M13 infect E. coli more efficiently than peptide expressing phage due to the changes to the gene 3 proteins. The final eluate was titred and again showed a much higher specific elution with Levamisole than the buffer wash. Blue plaques were picked from titre plates and sequenced. A consensus sequence of CTTMHPRLC was obtained.

### EXAMPLE 6

Disruption of Chemoreception in Plant Parasitic Nematodes Using the Animal Parasitic Nematode Anthelmintic Levamisole.

Freshly hatched H. glycines were incubated for 16 hours at room temperature in various concentrations of Levamisole. They were tested using the bioassay in example 3.

Results

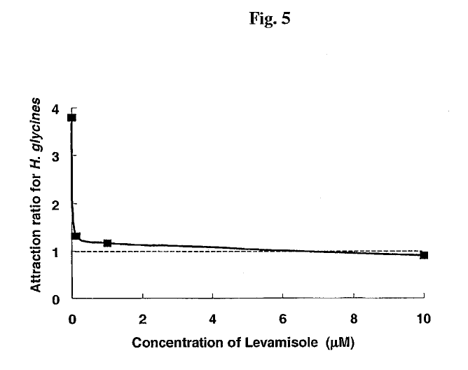

The nematodes did not show any signs of paralysis. The results are presented in FIG. 5. They show that a veterinary pharmaceutical against animal parasitic nematodes which is considered to only affect their neuromuscular junctions can inhibit chemoreception in a dose-dependent manner when presented at low concentrations.

### EXAMPLE 7

Disruption of Chemoreception in Plant Parasitic Nematodes Using a Binding Mimetic of the Animal Parasitic Nematode Anthelmintic Levamisole.

Heterodera glycines and Globodera pallida were incubated for 16 h in a solution containing the constrained peptide binding mimetic of levamisole (CTTMHPRLC) at a concentration of 1×10⁻⁶ M. The nematodes were then tested using the bioassays as described for each species in Example 3. The two species gave similar results and the data has been pooled. Treated animals did not respond to the attractant. The mean value ratio of nematodes under the disc with the attractant rather than without it was 2.41±0.48. In contrast, the nematodes pre-treated with the peptide CTTMHPRLC showed a corresponding ratio of 1.03±0.11. These values differ significantly (P<0.05; t-test) but the latter is similar to a value of 1. As values>1 indicate a chemoreceptive response, the data establishes a total loss of chemoreception after pre-treatment with 1×10⁻⁶ M of the peptide. Chemoreceptive function was still inhibited 3 hours after the start of the bioassay. The ratios for untreated and peptide treated H. glycines were significantly different at 1.93±0.07 and 1.24±0.11 respectively (P<0.01; t-test). This shows that the effects of the peptide remain after the nematodes have been removed from the treatment for 3 hours.

### EXAMPLE 8

Biopanning of Peptide Mimetic of Piperazine Using Nematode GABA Receptor.

C. elegans (N2 wildtype) were grown on 9 cm agar plates using Nematode Growth Medium and E. coli (OP50). Once well populated, the worms were washed off the agar plate using 2 ml ice-cold MAN buffer (10 mM 3-(N-morphilino)propanesulfonic acid, pH 6.8, 100 mM NaCl, 10 mM NaN₃), collected into 15 ml test tube and left to settle for 5 min. The worm pellet was passaged to a fresh tube of 2 ml ice-cold MAN buffer, left to settle and the process repeated again.

To make a membrane suspension, the worm pellet was sonicated on ice in 5×10 s bursts on full power diluted 1:1 with ice-cold MAN buffer. The homogenate was freeze thawed×5 in liquid N₂. Homogenate was then transferred to a Dounce homogeniser and subjected to 5×30 passes of the homogeniser on ice with 5 min gap between each 30 passes. Volume was made up to 1.5 ml in ice-cold MAN buffer and spun at 33,000 g for 30 min at 4° C. Pellet was resuspended in 1 ml ice-cold MAN buffer, aliquoted into 100 μl samples, snap frozen in liquid N₂ and stored at −80° C. until required.

100 μl aliquot of membrane fraction was diluted in 900 μl TBS with 0.1% Tween 20. 10 μl of original constrained phage library was added to this and incubated on a rotator for 1 hr. To remove unbound phage, the membrane fraction was pelleted by centrifugation at 13,000 g in a microfuge at 4° C. for 5 mins, supernatant removed, then the pellet was resuspended in 1 ml fresh TBS Tween. This was repeated 5 times followed by a final wash in TBS with no Tween.

Phage that specifically bound to GABA receptor were eluted using Piperazine at 10 mg/ml in TBS. The membrane fraction was pelleted by centrifugation and the supernatant retained and amplified for 4.5 hrs at 37° C. in host E. coli as previously described. This amplified first fraction was titred and the biopan against C. elegans membrane fraction was repeated using fresh extract with phage at an initial input value of 1×10¹¹ pfu.

After 2^{nd} round of biopanning, a 10 minute buffer wash was retained to investigate levels of specific elution by titring both buffer and piperazine elution.

Buffer 5.9×10⁴ pfu in 10 μl

Piperazine 3.0×10⁵ pfu in 10 μl

This example demonstrates the potential of the approach described in example 5, obtaining specific binding of peptides to a nematode derived GABA receptor. Using this approach, completely new peptides can be generated against specific targets and their sequences obtained. Following the procedures of examples 6 and 7, these other targets and peptides of interest can be further investigated.

1. A method for combating crop pests or animal parasites by contacting them with a peptide which has a molecular weight of 12,000 Dalton or less, which is able to exert its effect after entry into the neurons of the crop pest or in the synaptic cleft and which is able to be taken up through retrograde neuronal transport starting from a sense organ.

2. A method according to claim 1, characterised in that the crop pest or animal parasite is an invertebrate.

3. A method according to claim 2 wherein the crop pest or animal parasite is a nematode.

4. A method according to claim 2 wherein the crop pest is a pulmonate gastropod mollusc.

5. A method according to claim 2 wherein the crop pest is an oligochaete annelid.

6. A method according to claim 2 wherein the crop pest is an arthropod.

7. A method according to claim 6 wherein the crop pest is an insect.

8. A method according to claim 6 wherein the crop pest is a mite.

9. A method according to claim 2 wherein the animal parasite is a helminth.

10. Method according to claim 1, characterised in that the peptide is a binding mimetic of acetylcholine interfering with the normal functioning of this neurotransmitter and its interaction with its receptor and its degradation by acetylcholinesterase.

11. Method according to claim 10, characterised in that the peptide is an inhibitor of acetylcholinesterase.

12. Method according to claim 11 characterised in that the peptide comprises the amino acid sequence SVSVGMKPSPRP or the constrained amino acid sequence CSINWRHHC.

13. Method according to claim 11, characterised in that the peptide comprises the amino acid sequence SINWRHH.

14. Method according to claim 1, characterised in that the peptide is a binding mimetic of the anthelmintic levamisole interfering with the normal functioning of an acetylcholine receptor or other sites to which levamisole binds.

15. Method according to claim 14, characterised in that the peptide comprises the amino acid sequence CTTMHPRLC or TTMHPRL.

16. Method according to any of claim 1-13, characterised in that a plant has been transformed with a nucleic acid encoding the peptide.

17. Method according to claim 16, wherein the transgenic plant is a dietary crop for the host animal.

18. Method according to any of claim 1-13, characterised in that the peptide is expressed by a transgenic microorganism which can be used as a feed supplement for the host animal.

19. Peptide having a molecular weight of 12,000 Dalton or less comprising the amino acid sequence SINWRHH, SVSVGMKPSPRP or TTMHPRL.

20. Peptide according to claim 19 comprising the amino acid sequence CSINWRHHC or CTTMHPRLC.

21. Polynucleotide encoding one or more repeats of a peptide according to claim 19 or 20.

22. Expression construct comprising the polynucleotide according to claim 21 operably linked to a transcription initiation region.

23. Vector comprising the expression construct according to claim 22.

24. Microorganism comprising the vector according to claim 23.

25. Organism transformed with an expression construct according to claim 22 or a vector according to claim 23.

26. Organism according to claim 25, characterised in that it is a bacterium, a yeast, a fungus, an insect, a plant, or a cell from a cell culture.

27. Organism according to claim 26, characterised in that it is a plant.

28. Plant according to claim 27, characterised in that it is a potato plant.

29. A method for identifying peptides active against crop pests or animal parasites, which peptides are able to be taken up through retrograde neuronal transport starting from a sense organ of said pest or parasite and able to exert its effect after entry into the neurones of said pest or parasite comprising the steps of:
a) obtaining an isolated suspension of a target compound from said pest or parasite, which compound is known to be a target for a pesticide or which compound if inhibited would inhibit neuronal functioning of said pest or parasite;
b) biopanning phages from a phage peptide or protein library against said target compound;
c) isolating the phages binding to the target compound;
d) isolating the peptide insert from the phage;
e) sequencing said peptide insert;
f) synthesise an amount of peptide according to this sequence;
g) test said amount in a behavioural bioassay; and
h) identify the peptide if said amount negatively affects chemoreception.

30. A method according to claim 29 wherein the target compound is acetylcholinesterase.

31. A method according to claim 29 wherein the target compound is a nicotinic acetylcholine receptor.

32. A method according to claim 29 wherein the target compound is selected from the group consisting of sensory sensillae receptor molecules, anterograde or retrograde transport motors, kinesin, dynein, dynactin and housekeeping compounds which are specific for a crop pest or animal parasite.

33. Peptide identified by a method according to any of claims 29-32.

34. A pharmaceutical composition comprising the peptide according to any of claim 19, 20 or 33.

35. A composition adapted for oral, parenteral or topical administration to a host animal which comprises a peptide according to any of claims 19, 20 or 33 and a pharmaceutically acceptable incipient.

36. Use of a plant according to claim 27 as a dietary crop for a host animal.
